(19) United States
(12) Patent Application Publication
(10) Pub. No.: US 2009/0079983 A1
(43) Pub. Date: Mar. 26, 2009

(54) Surface inspection device

(75) Inventors: Yoshihiko Fujimori, Yokohama-shi (JP); Yuwa Ishii, Yokohama-shi (JP)

Correspondence Address: MORGAN LEWIS & BOCKIUS LLP, 1111 PENNSYLVANIA AVENUE NW, WASHINGTON, DC, 20004, US

(73) Assignee: Nikon Corporation

(21) Appl. No.: 12/292,393

(22) Filed: Nov. 18, 2008

Related U.S. Application Data
(63) Continuation of application No. PCT/JP2007/061252, filed on May 29, 2007.

(30) Foreign Application Priority Data
Jun. 1, 2006 (JP) 2006-153724

(51) Int. Cl. G01J 4/00

(52) U.S. Cl. 356/369

(57) ABSTRACT

A surface inspection device includes an illumination optical system that illuminates, with a linearly polarized light, a surface of a wafer where a repeated pattern is formed; an alignment stage that holds the wafer; a pick-up optical system that picks up an image of reflected light from the surface of the wafer; an image storage unit that stores the image picked up by the pick-up optical system; an image processing unit that performs predetermined image processing on the image stored in the image storage unit and detects a defect of the repeated pattern; and an image output unit that outputs the results of the image processing by the image processing unit. The orientation of the transmission axis of a second polarizing plate is set to be inclined at 45 degrees with respect to the transmission axis of a first polarizing plate.

This is a continuation of PCT International Application No. PCT/JP2007/061252, filed May 29, 2007, which is hereby incorporated by reference. This application also claims the benefit of Japanese Patent Application No. 2006-153724, filed in Japan on Jun. 1, 2006, which is hereby incorporated by reference.

### TECHNICAL FIELD

The present invention relates to a surface inspection device that inspects a surface of a semiconductor wafer or liquid-crystal substrate.

### TECHNICAL BACKGROUND

Progress in miniaturization of semiconductors has been accompanied by increase in NA (numerical aperture) of exposure devices and, therefore, now the exposure conditions such as focus and dose have to be strictly controlled. Defects caused by focus and dose errors in a resist pattern after the exposure have been conventionally inspected by a pattern edge roughness inspection technique (see, for example, PCT Patent Publication No. WO 2005/040776 which also corresponds to US Patent Publication No. 2006/0192953).

### DISCLOSURE OF THE INVENTION

### Problems to be Solved by the Invention

However, when the inspection is performed by the aforementioned technique, because the quantity of light (variation in quantity of light) detected in the so-called cross-Nicol state is small, it is necessary to use a high-sensitivity pick-up element or to perform image acquisition within a long period. The problem is that when a high-sensitivity pick-up element is used, the device cost is increased, and when image acquisition is performed within a long period, the throughput decreases.

The present invention has been created with consideration for such a problem, and it is an object thereof to provide a surface inspection device that enables inexpensive inspection at a high throughput.

### Means to Solve the Problems

In order to attain the above-described object the surface inspection device of the first invention comprises: an illumination system to illuminate, with a first linearly polarized light, a surface of a substrate to be inspected that has a repeated pattern formed thereon; a pick-up system to pick up an image of a reflected light from the surface of the substrate to be inspected; and an image display system to display the image picked up by the pick-up system, wherein a polarization element that extracts a second linearly polarized light from the reflected light from the surface of the substrate to be inspected is installed between the substrate to be inspected and the pick-up system, and the pick-up system picks up an image created by a light including the second linearly polarized light, and wherein the polarization element is set so that an angle at which an oscillation direction of the second linearly polarized light in a plane perpendicular to a propagation direction of the second linearly polarized light is inclined to an oscillation direction of the first linearly polarized light in a plane perpendicular to a propagation direction of the first linearly polarized light is larger than 0 degree and smaller than 90 degrees.

In such surface inspection device, it is preferred that the polarization element be set so that an angle at which the oscillation direction of the second linearly polarized light in the plane perpendicular to the propagation direction of the second linearly polarized light is inclined to the oscillation direction of the first linearly polarized light in the plane perpendicular to the propagation direction of the first linearly polarized light is equal to or larger than 45 degrees and smaller than 90 degrees.

In such surface inspection device, it is further preferred that the polarization element be set so that an angle at which the oscillation direction of the second linearly polarized light in the plane perpendicular to the propagation direction of the second linearly polarized light is inclined to the oscillation direction of the first linearly polarized light in the plane perpendicular to the propagation direction of the first linearly polarized light is approximately 45 degrees.

In the surface inspection device, the pick-up system can pick up the entire repeated pattern.

The surface inspection device of the second invention comprises: an illumination system to illuminate, with a first linearly polarized light, a surface of a substrate to be inspected that has a repeated pattern formed thereon; a pick-up system for picking up an image of a reflected light from the surface of the substrate to be inspected; an image processing unit to perform a predetermined image processing on the image picked up by the pick-up system and to detect a defect of the repeated pattern; and an image output unit to output results of the image processing performed by the image processing unit, wherein a polarization element that extracts a second linearly polarized light from the reflected light from the surface of the substrate to be inspected is installed between the substrate to be inspected and the pick-up system, and the pick-up system picks up an image created by a light including the second linearly polarized light, and wherein the polarization element is set so that an angle at which an oscillation direction of the second linearly polarized light in a plane perpendicular to a propagation direction of the second linearly polarized light is inclined to an oscillation direction of the first linearly polarized light in a plane perpendicular to a propagation direction of the first linearly polarized light is larger than 0 degree and smaller than 90 degrees.

In such surface inspection device, it is preferred that the polarization element be set so that an angle at which the oscillation direction of the second linearly polarized light in the plane perpendicular to the propagation direction of the second linearly polarized light is inclined to the oscillation direction of the first linearly polarized light in the plane perpendicular to the propagation direction of the first linearly polarized light is equal to or larger than 45 degrees and smaller than 90 degrees.

In such surface inspection device, it is further preferred that the polarization element be set so that an angle at which the oscillation direction of the second linearly polarized light in the plane perpendicular to the propagation direction of the second linearly polarized light is inclined to the oscillation direction of the first linearly polarized light in the plane perpendicular to the propagation direction of the first linearly polarized light is approximately 45 degrees.

It is preferred that this surface inspection device further comprise a holding unit to hold the substrate to be inspected so that an angle formed by an orientation of an oscillation plane of the first linearly polarized light at the surface of the substrate to be inspected and a repetition direction of the repeated pattern is a predetermined angle, wherein the predetermined angle is set to approximately 45 degrees by the holding unit.

The invention of the above-described configuration enables inexpensive inspection at a high throughput.

### BRIEF DESCRIPTION OF THE DRAWINGS

FIG. 1 illustrates the entire configuration of the surface inspection device in accordance with the present invention.

FIG. 2 shows an external appearance of a semiconductor wafer surface.

FIG. 3 is a perspective view illustrating a peak-valley structure of a repeated pattern.

FIG. 4 illustrates the inclination state of the incidence plane of the linearly polarized light and the repetition direction of the repeated pattern.

FIG. 5 illustrates the oscillation directions of the linearly polarized light and elliptically polarized light.

FIG. 6 illustrates the inclination state of the orientation of the oscillation plane of the linearly polarized light and the repetition direction of the repeated pattern.

FIG. 7 illustrates a mode of separating a polarization light component in which the orientation of the oscillation plane of the linearly polarized light is parallel to the repetition direction and a polarization light component in which the orientation of the oscillation plane of the linearly polarized light is perpendicular to the repetition direction.

FIG. 8 illustrates the relationship between the size of a polarization light component and a line width of a line portion of the repeated pattern.

FIG. 9 illustrates the relationship between the orientation of a transmission axis of a second polarizing plate with respect to a transmission axis of a first polarizing plate and the variation in quantity of light.

FIG. 10 illustrates a first modification example of the surface inspection device.

FIG. 11 illustrates a second modification example of the surface inspection device.

### DESCRIPTION OF THE PREFERRED EMBODIMENTS

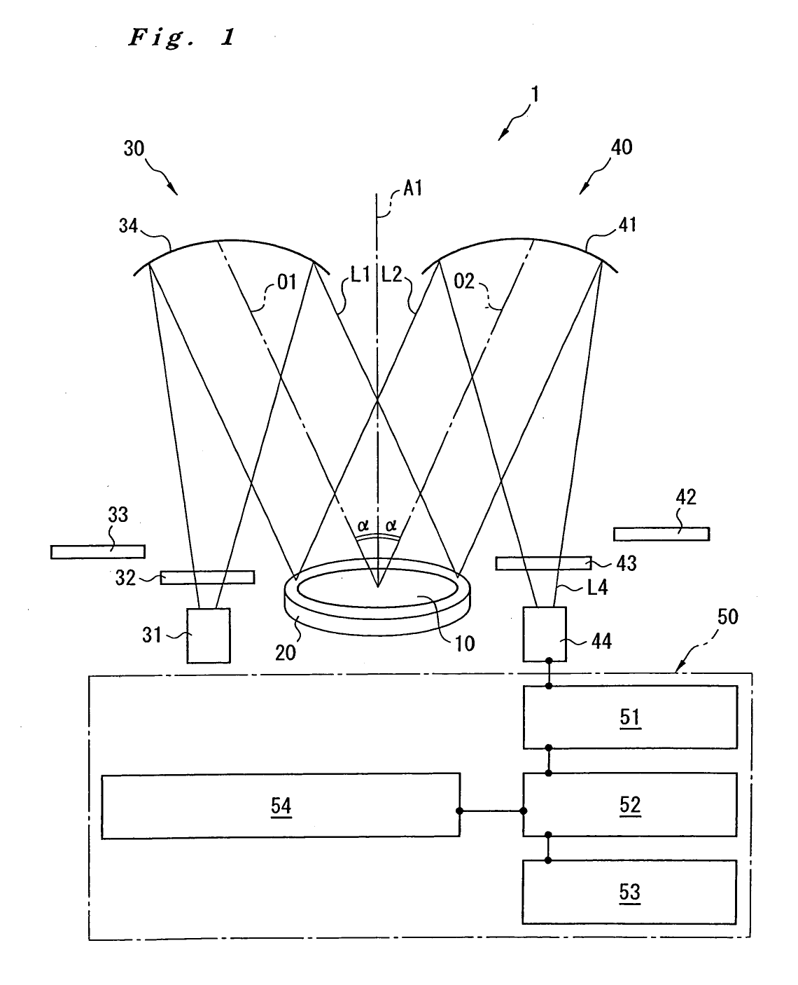

The preferred embodiments of the present invention will be described below with reference to the appended drawings. As shown in FIG. 1, a surface inspection device 1 of the present embodiment comprises an alignment stage 20 that supports a semiconductor wafer 10, which is the substrate to be inspected, an illumination optical system 30, a pick-up optical system 40, and an image processing device 50 as the main components. The surface inspection device 1 automatically performs the inspection of the surface of the wafer 10 in the process of manufacturing a semiconductor circuit element. After a resist layer film of the uppermost layer of the wafer 10 has been exposed and developed, the wafer is transported by a transportation system (not shown in the figure) from a wafer cassette or development device (not shown in the figure) and suction held at the alignment stage 20.

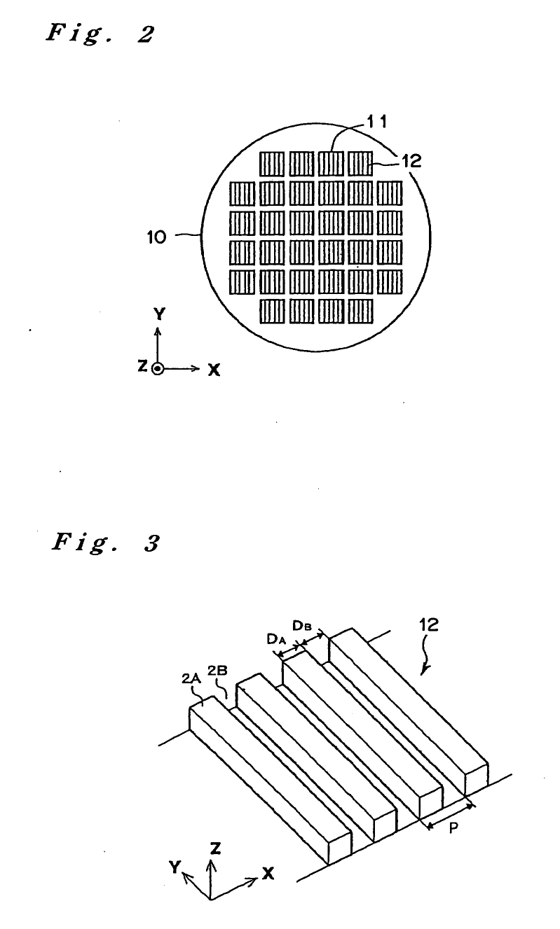

As shown in FIG. 2, a plurality of chip regions 11 are arranged in the XY directions on the surface of the wafer 10, and a predetermined repeated pattern 12 is formed within each chip region. As shown in FIG. 3, the repeated pattern 12 is a resist pattern (for example, a wiring pattern) in which a plurality of line portions 2A are arranged side by side with a predetermined pitch P along the short-side direction (x direction) thereof. The space between the adjacent line portions 2A is a space portion 2B. The arrangement direction (X direction) of the line portions 2A will be referred to as “the repetition direction of the repeated pattern 12”.

Here, a design value of a line width D_{A} of the line portion 2A in the repeated pattern 12 is ½ of the pitch P. Where the repeated pattern 12 is formed according to the design value, the line width D_{A} of the line portions 2A and a line width D_{B} of the space portion 2B are equal to each other and the volume ratio of the line portions 2A and 2B is about 1:1. By contrast, where the exposure focus deviates from an appropriate value when the repeated pattern 12 is formed, the pitch P is not changed, but the line width D_{A} of the line portion 2A becomes different from the design value and also different from the line width D_{B} of the space portion 2B. As a result, the volume ratio of the line portions 2A and space portions 2B deviates from about 1:1.

The surface inspection device 1 of the present embodiment performs the defect inspection of the repeated pattern 12 by using the variation in the volume ratio of the line portions 2A and space portions 2B in such a repeated pattern 12. To simplify the explanation, the perfect volume ratio (design value) will be taken as 1:1. The variation of the volume ratio is caused by the deviation of exposure focus and observed for each shot region of the wafer 10. The volume ratio can be also called the surface area ratio of cross sections.

In the present embodiment, the pitch P of the repeated pattern 12 is taken to be sufficiently small by comparison with the wavelength of illumination light (described hereinbelow) falling on the repeated pattern 12. As a result, no diffraction light is generated from the repeated pattern 12, and the defect inspection of the repeated pattern 12 is not performed based on the diffracted light. The principle of the defect inspection in the present embodiment will be explained below together with the configuration (FIG. 1) of the surface inspection device.

The alignment stage 20 supports the wafer 10 on the upper surface thereof, and fixedly holds the wafer, for example, by vacuum suction. Further, the alignment stage 20 can rotate about a normal A1 in the center of the upper surface. The repetition direction (X direction in FIG. 2 and FIG. 3) of the repeated pattern 12 in the wafer 10 can be rotated by the rotation mechanism within the surface of the wafer 10. The upper surface of the alignment stage 20 is a horizontal surface and the alignment stage has no tilt mechanism. Therefore, the wafer 10 can be maintained in a horizontal state at all times.

The alignment stage 20 that rotates in the above-described manner is stopped in a predetermined position. As a result, the repetition direction (X direction in FIG. 2 and FIG. 3) of the repeated pattern 12 in the wafer 10 can be inclined and set at an angle of 45 degrees to an incidence surface of the below-described illumination light (oscillation surface of the oscillation light).

The illumination optical system 30 has a lamp house 31, a first polarizing plate 32, a first phase plate 33, and a first elliptical mirror 34 and serves to illuminate the repeated pattern 12 of the wafer 10 located on the alignment stage 20 with a linearly polarized light L1 (first linearly polarized light). The linearly polarized light L1 is an illumination light with respect to the repeated pattern 12. The linearly polarized light L1 illuminates the entire surface of the wafer 10.

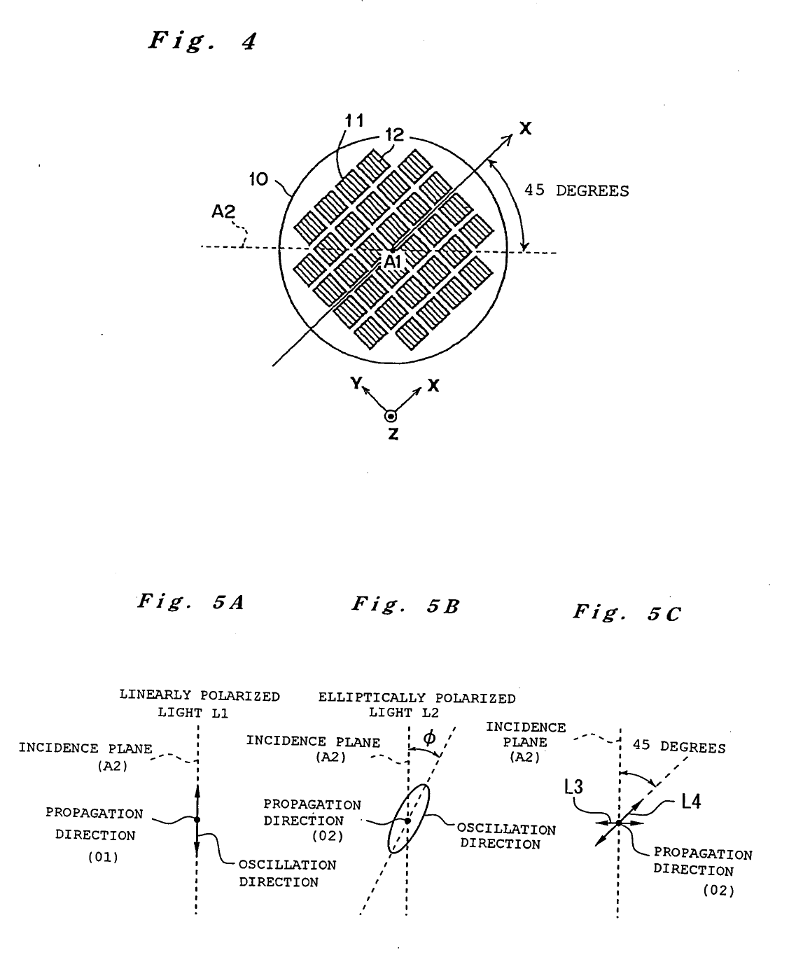

The propagation direction of the linearly polarized light L1 (the direction of the main light beam of the linearly polarized light L1 that reaches any point on the surface of the wafer 10) is almost parallel to the optical axis O1 from the first elliptical mirror 34. The optical axis O1 passes through the center of the alignment stage 20 and is tilted at a predetermined angle α to the normal A1 of the alignment stage 20. A plane parallel to the normal A1 of the alignment stage 20, including the propagation direction of the linearly polarized light L1, is an incidence plane of the linearly polarized light L1. An incidence plane A2 shown in FIG. 4 is an incidence plane in the center of the wafer 10.

In the present embodiment, the linearly polarized light L1 is a p-polarized light. In other words, as shown in FIG. 5(a), a plane (oscillation plane of the linearly polarized light L1) including the propagation direction of the linearly polarized light L1 and an oscillation direction of an electric (or magnetic vector) is included in the incidence plane A2 of the linearly polarized light L1. The oscillation plane of the linearly polarized light L1 is determined by the transmission axis of the first polarizing plate 32 disposed between the lamp house 31 and the first elliptical mirror 34.

The lamp house 31 contains inside thereof a light source comprising an ultrahigh-pressure mercury lamp and a wavelength-selective filter (not shown in the figure) and emits light of a predetermined wavelength. The light source is not limited to the mercury lamp, and a metal halide lamp may be also used. The wavelength-selective filter selectively transmits an emission-line spectrum of a predetermined wavelength from the light produced by the mercury lamp light source.

The first polarizing plate 32 is disposed between the lamp house 31 and the first elliptical mirror 34, and the transmission axis thereof is set to a predetermined orientation. The first polarizing plate 32 produces a linearly polarized light from the light from the lamp house 31 correspondingly to the transmission axis. The first phase plate 33 is disposed so that it can be inserted in and pulled out from the space between the first polarizing plate 32 and first elliptical mirror 34 and is used to correct the disturbance of light reflected by the first elliptical mirror 34. The first elliptical mirror 34 converts the light from the lamp house 31 that is reflected by the first elliptical mirror 34 into a parallel light flux and illuminates the wafer 10, which is a substrate to be inspected.

In the above-described illumination optical system 30, the light from the lamp house 31 passes through the first polarizing plate 32 and first elliptical mirror 34 and becomes a p-polarized linearly polarized light L1 which illuminates the entire surface of the wafer 10. The incidence angle of the linearly polarized light L1 in each point of the wafer 10 is the same because of a parallel light flux and corresponds to the angle α between the optical axis O1 and normal A1.

In the present embodiment, because the linearly polarized light L1 falling on the wafer 10 is a p-polarized light, where the repetition direction (x direction) of the repeated pattern 12 is set to an angle of 45 degrees to the incidence plane A2 (propagation direction of the linearly polarized light L1 at the surface of the wafer 10) of the linearly polarized light L1, as shown in FIG. 4, the angle between the direction of the oscillation plate of the linearly polarized light L1 at the surface of the wafer 10 and the repetition direction (x direction) of the repeated pattern 12 will be also set to 45 degrees.

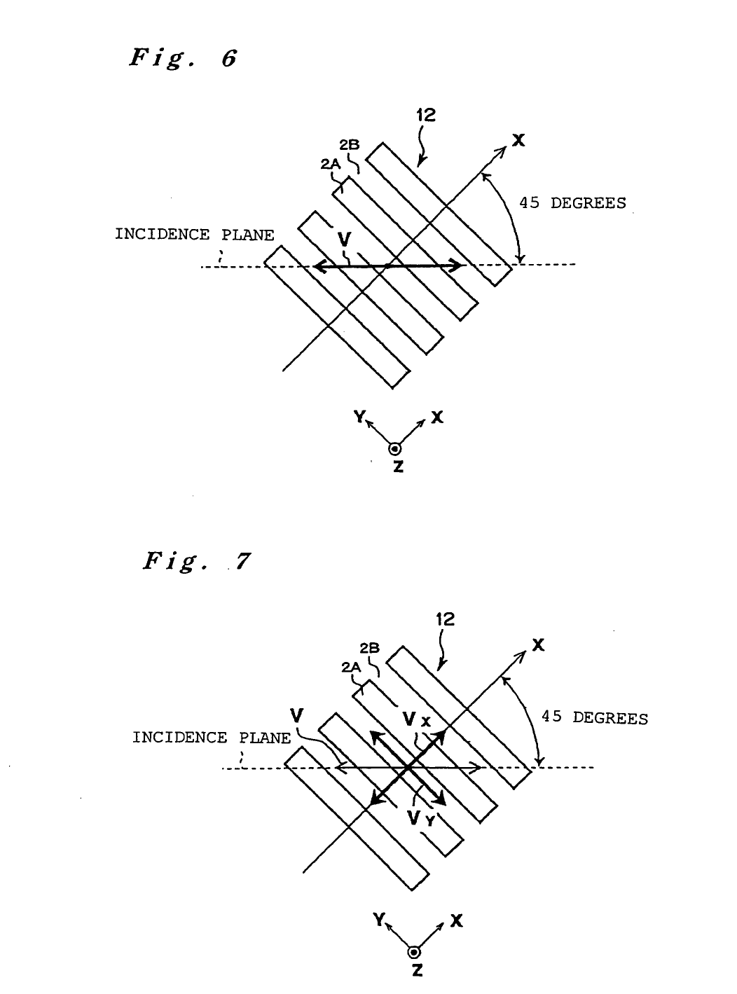

In other words, in a state in which the direction (V direction in FIG. 6) of the oscillation plane of the linearly polarized light L1 at the surface of the wafer 10 is inclined at an angle of 45 degrees to the repetition direction (x direction) of the repeated pattern 12, the linearly polarized light L1 will fall on the repeated pattern 12 by obliquely crossing the repeated pattern 12.

Such an angular state of the linearly polarized light L1 and repeated pattern 12 is uniform over the entire surface of the wafer 10. Further, the same angular state of the linearly polarized light L1 and repeated pattern 12 is obtained when the angle of 45 degrees is replaced with 135 degrees, 225 degrees, or 315 degrees. The angle formed by the direction (V direction) of the oscillation plane shown in FIG. 6 and the repetition direction (X direction) is set to 45 degrees to obtain the highest sensitivity of defect inspection of the repeated pattern 12.

Where the repeated pattern 12 is illuminated using the above-described linearly polarized light L1, an elliptically polarized light L2 is generated in the specular direction from the repeated pattern 12 (see FIG. 1 and FIG. 5(b)). In this case, the propagation direction of the elliptically polarized light L2 matches the specular direction. The specular direction as referred to herein is a direction that is included in the incidence plane A2 of the linearly polarized light L1 and inclined at an angle α (angle equal to the incidence angle α of the linearly polarized light L1) to the normal A1 of the alignment stage 20. As described above, because the pitch P of the repeated pattern 12 is larger than the illumination wavelength, no diffracted light is generated from the repeated pattern 12.

Here, the reasons for the linearly polarized light L1 being converted into an elliptically polarized light by reflection at the repeated pattern 12 and the elliptically polarized light L2 being generated from the repeated pattern 12 will be explained below in a simple manner. Where the linearly polarized light L1 falls on the repeated pattern 12, the direction of the oscillation plane (V direction in FIG. 6) is divided into two polarization components Vₓ, V_{y} shown in FIG. 7. One polarization component Vₓ is a component parallel to the repetition direction (X direction). The other polarization component V_{y} is a component perpendicular to the repetition direction (X direction). The two polarization components Vₓ, V_{y} independently undergo different amplitude variations and phase variations. The amplitude variations and phase variations are different because of the difference in a complex reflection factor (that is, an amplitude reflection factor of a complex number) caused by anisotropy of repeated pattern 12, and these variations are called “form birefringence”. As a result, the reflected lights of the two polarization components Vₓ, V_{y} have mutually different amplitudes and phases, and the reflected light obtained by synthesis thereof becomes the elliptically polarized light L2 (see FIG. 5(b)).

Further, the degree of conversion into the elliptically polarized light caused by anisotropy of repeated pattern 12 can be considered as a polarization component L3 (see FIG. 5(c)) perpendicular to the oscillation plane of the linearly polarized light L1 shown in FIG. 5(a), from among the elliptically polarized light L2 shown in FIG. 5(b). The size of the polarization component L3 depends on the material and shape of the repeated pattern 12 and the angle formed by the direction (V direction) of the oscillation plane shown in FIG. 6 and the repetition direction (X direction). Therefore, when a constant angle (45 degrees in the present embodiment) is maintained between the V direction and X direction, the degree of conversion into the elliptically polarized light (size of the polarization component L3) will vary where the shape of the repeated pattern 12 changes, even when the material of the repeated pattern 12 is the same.

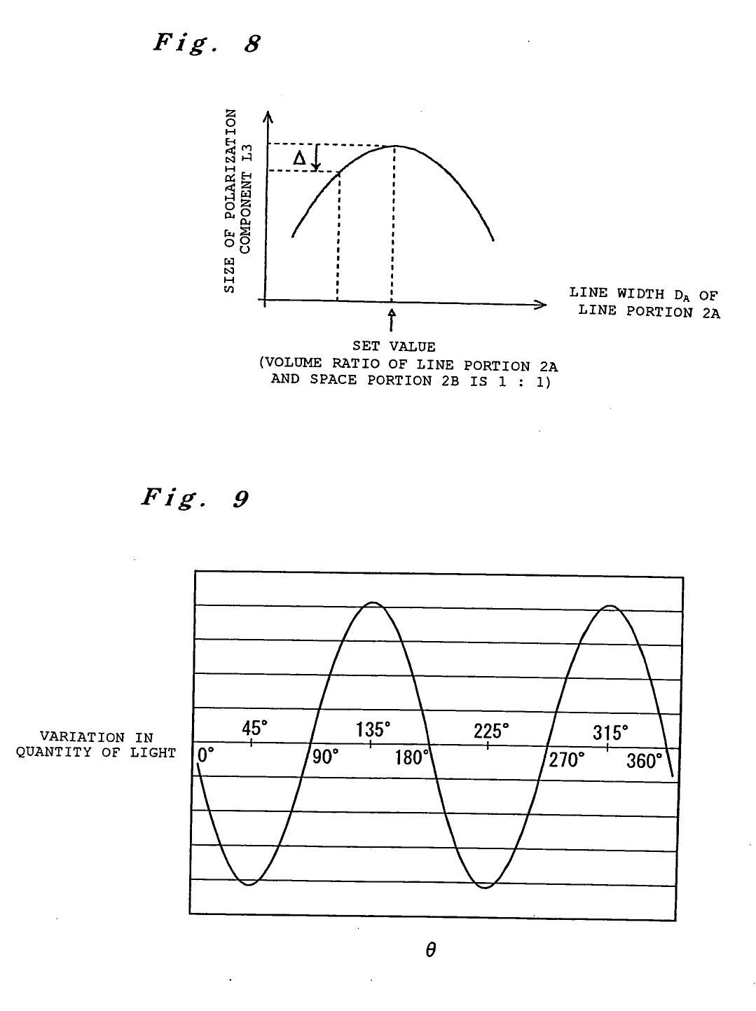

The relationship between the shape of the repeated pattern 12 and the size of the polarization component L3 will be described below. As shown in FIG. 3, the repeated pattern 12 has a peak-valley shape in which the line portions 2A and space portions 2B are arranged alternately side by side along the X direction, and where they are formed according to the designed values with an appropriate exposure focus, the line width D_{A} of the line portions 2A is equal to the line width D_{B} of the space portions 2B and the volume ratio of the line portions 2A and space portions 2B deviates from about 1:1. In this case, the size of the polarization component L3 becomes less than that in the ideal case. FIG. 8 illustrates the variation of the size of the polarization component L3. In FIG. 8, the line width D_{A} of the line portions 2A is plotted against the abscissa.

Thus, where the repeated pattern 12 is illuminated using the linearly polarized light L1 in a state in which the direction (V direction) of the oscillation plane shown in FIG. 6 is inclined at an angle of 45 degrees to the repetition direction (X direction) of the repeated pattern 12, the degree of conversion into the elliptically polarized light (size of the polarization component L3 in FIG. 5(c)) of the elliptically polarized light L2 produced by reflection in the specular direction will correspond to the shape (volume ratio of the line portions 2A and space portions 2B) of the repeated pattern 12. The propagation direction of the elliptically polarized light L2 is included in the incidence plane A2 of the linearly polarized light L1 and inclined at an angle α to the normal A1 of the alignment stage 20.

As shown in FIG. 1, the pick-up optical system 40 comprises a second elliptical mirror 41, a second phase plate 42, a second polarizing plate 43, and a pick-up camera 44. The second elliptical mirror 41 is a reflection mirror identical to the first elliptical mirror 34 of the illumination optical system 30. The second elliptical mirror is installed so that an optical axis O2 thereof passes through the center of the alignment stage 20 and is inclined at an angle α to the normal A1 of the alignment stage 20. Therefore, the elliptically polarized light L2, which is the reflection light from the repeated pattern 12, propagates along the optical axis O2 of the second elliptical mirror 41. The second elliptical mirror 41 reflects the elliptically polarized light L2 and collects it on the pick-up plane of the pick-up camera 44.

The second polarizing plate 43 is installed between the second elliptical mirror 41 and pick-up camera 44. The orientation of the transmission axis of the second polarizing plate 43 is set to be inclined at an angle of 45 degrees to the transmission axis of the first polarizing plate 32 of the above-described illumination optical system 30. Therefore, where the elliptically polarized light L2 passes through the second polarizing plate 43, the polarization component thereof, that is, a linearly polarized light L4 (second linearly polarized light) from the second polarizing plate 43, is collected on the pick-up plane of the pick-up camera 44. As a result, a reflected image of the waver 10 created by the linearly polarized light L4 is formed on the pick-up plane of the pick-up camera 44. Further, the second phase plate 42 is installed so that it can be inserted in and pulled out from the space between the second elliptical mirror 41 and second polarizing plate 43 and is used to correct the disturbance of light reflected by the second elliptical mirror 41.

The pick-up camera 44 is a CCD camera having a CCD pick-up element (not shown in the figure). The pick-up camera photoelectrically converts a reflected image of the waver 10 formed in the pick-up plane and outputs an image signal to an image storage unit 51 of an image processing device 50. The lightness of the reflected image of the wafer 10 is substantially proportional to light intensity of the linearly polarized light L4 and varies correspondingly to the shape of the repeated pattern 12. Where the repeated pattern 12 has an ideal shape, the reflected image of the wafer 10 has the highest lightness. The lightness of the reflected image of the wafer 10 is demonstrated for each shot region.

The image processing device 50 comprises the image storage unit 51, an image processing unit 52 electrically connected to the image storage unit 51, an image output unit 53 electrically connected to the image processing unit 52, and a system control unit 54 that performs systematic control of the operation of the aforementioned units. In the image processing device, the reflected image of the wafer 10 is fetched into the image storage unit 51 based on the image signal outputted from the pick-up camera 44. A reflected image of high-quality wafer (not shown in the figure) has been stored in advance for comparison in the image storage unit 51. The luminance information of the reflected image of this high-quality wafer can be considered as indicating the highest luminance value.

Where the reflected image of the wafer 10, which is the substrate to be inspected, is fetched into the image storage unit 51, the image processing unit 52 compares the luminance information of the image with the luminance information of the reflected image of the high-quality wafer. In this case, a defect of the repeated pattern 12 is detected based on the decrease (variation of the quantity of light) in the luminance value of a dark zone in the reflected image of the wafer 10. For example, “Defect” may be determined if the decrease in the luminance value exceeds a preset threshold (allowed value) and “Normal State” may be determined when the decrease is less than the threshold. The comparison results of the luminance information obtained with the image processing unit 52 and the reflected image of the wafer 10 at this time are outputted to and displayed by the image output unit 53.

The image processing unit 50 may be configured to store in advance the reflected image of the high-quality wafer in the image storage unit 51, as described hereinabove, and also may be configured to store in advance the arrangement data of the shot regions of the wafer 10 and the threshold of the luminance value. In this case, the position of each shot region in the reflected image of the fetched wafer 10 is determined based on the arrangement data of shot regions, and the luminance value of each shot region is found. The defective pattern is detected by comparing this luminance value with the threshold that has been stored. The shot region in which the luminance value is below the threshold may be determined as “Defect”.

Where the linearly polarized light L1 falls obliquely on the surface of the wafer 10, as in the present embodiment, the elliptically polarized light L2 generated from the repeated pattern 12, strictly speaking, slightly rotates about the propagation direction thereof as an axis. The rotation angle of the elliptically polarized light L2 is taken as φ, as shown in FIG. 5(b).

In the conventional surface inspection device, the orientation of the transmission axis of the second polarizing plate 43 is set to be inclined at an angle of 90 degrees to the transmission axis of the first polarizing plate 32, that is, the oscillation direction of the linearly polarized light L4 in the plane perpendicular to the propagation direction of the linearly polarized light L4 is set to be inclined at an angle of 90 degrees to the oscillation direction of the linearly polarized light L1 in the plane perpendicular to the propagation direction of the linearly polarized light L1. When surface inspection of the wafer 10 is performed using the conventional surface inspection device, where the rotation angle of the elliptically polarized light L2 created by the reflection at the wafer 10 is taken as φ, as shown in FIG. 5(b), the variation in the quantity of light reaching the pick-up camera 44 is proportional to sin²φ. Such rotation is generated by the repeated pattern 12 and varies depending on the focus or dose during the exposure. However, the rotation angle θ of the elliptically polarized light L2 has a small value and, therefore, the variation in the quantity of light reaching the pick-up camera 44 is extremely small.

Accordingly, in the conventional surface inspection device, it is necessary to use a high-sensitivity pick-up camera or pick up images for a long time.

By contrast, in the surface inspection device 1 of the present embodiment, as described hereinabove, the orientation of the transmission axis of the second polarizing plate 43 is set to be inclined at an angle of 45 degrees to the transmission axis of the first polarizing plate 32, that is, the oscillation direction of the linearly polarized light L4 within the plane perpendicular to the propagation direction of the linearly polarized light L4 is set to be inclined at an angle of 45 degrees to the oscillation direction of the linearly polarized light L1 within the plane perpendicular to the propagation direction of the linearly polarized light L1 (see FIGS. 5(a) and (c)). When surface inspection of the wafer 10 is performed using the surface inspection device 1 of the present embodiment, the variation in quantity of light reaching the pick-up camera 44 is proportional to −sinφ. As in the conventional device, the rotation of the elliptically polarized light L2 is caused by the repeated pattern 12 and varies depending on the focus or dose during the exposure.

The optical principle of the present embodiment will be described below. Where the polarization orientation (orientation of the transmission axis of the second polarizing plate 43 with respect to the transmission axis of the first polarizing plate 32) of the second polarizing plate 43 with respect to the illumination polarized light (linearly polarized light L1) is denoted by θ and the rotation orientation (that is, the rotation angle of the linearly polarized light L2 created by the reflection at the wafer 10) of the reflected polarized light (elliptically polarized light L2) with respect to the illumination polarized light (linearly polarized light L1) is taken as φ, the quantity of light that receives the rotation in reflection at the wafer 10 can be represented by Equation (1) and the quantity of light that does not receive the rotation can be represented by the Equation (2).

Quantity of light that received the rotation=cos²(θ+100) (1)

Quantity of light that has not received the rotation=cos²(θ) (2)

Therefore, the variation in the quantity of light occurring when the rotation is received can be represented by Equation (3) below.

Variation in quantity of light=cos²(θ+φ)−cos²(θ) (3)

When θ=90°, Equation (4) is obtained.

Variation in quantity of light=cos²(90°+φ)−cos²(90°)=sin²φ (4)

This Equation (4) corresponds to the conventional case. On the other hand, when 0=450, Equation (5) is obtained.

$$\begin{matrix}Variation in quantity of light = {cos}^{2} ( 45 ° + φ ) - {cos}^{2} ( 45 ° ) \\ = {( cos 45 ° \cdot cos φ - sin 45 ° \cdot sin φ )}^{2} - \\ {cos}^{2} 45 ° \\ = 1 / 2 {( cos φ - sin φ )}^{2} - 1 / 2\end{matrix}$$

Because the rotation angle φ herein is very small, Equation (5) can be represented as Equation (6).

Variation in quantity of light=−cosφ·sinφ≈−sinφ (6)

Therefore, where the rotation angle φ is small, the configuration with θ=45° clearly enables larger variation in quantity of light.

A graph in FIG. 9 shows the variation in quantity of light in Equation (3), which offers a general solution for the variation in quantity of light, wherein θ is taken as a variable (φ is taken as a constant). As follows from FIG. 9, when θ=45°, 135°, 225°, 315°, the variation in quantity of light reaches a maximum. Further, θ=45°, 135°, 225°, 315° are manners of taking the direction of θ, and in all these cases, the results are substantially identical to those obtained with θ=45°.

As a result, with the surface inspection device 1 of the present embodiment, the variation in quantity of light (amount of decrease in the luminance value) can be increased by setting the orientation of the transmission axis of the second polarizing plate 43 so that it is inclined at 45 degrees to the transmission axis of the first polarizing plate 32, that is, by setting the oscillation direction of the linearly polarized light L4 in a plane perpendicular to the propagation direction of the linearly polarized light L4 so that it is inclined at 45 degrees to the oscillation direction of the linearly polarized light L1 in a plane perpendicular to the propagation direction of the linearly polarized light L1. Therefore, inexpensive inspection can be performed at a high throughput, without the necessity of using an expensive high-sensitivity camera or performing the exposure for a long time.

Further, by setting an angle between the orientation of the oscillation plane (propagation direction of the linearly polarized light L1) in FIG. 6 and the repetition direction of the repeated pattern 12 to 45 degrees, it is possible to grasp large variations in quantity of light (amount of decrease in the luminance value) of the reflected image of the wafer 10 and the defect inspection of the repeated pattern 12 can be performed with high sensitivity.

In the surface inspection device 1 of the present embodiment, the pitch P of the repeated pattern 12 does not necessarily have to be sufficiently small by comparison with the illumination wavelength, and the defect inspection of the repeated pattern 12 can be performed in the same manner when the pitch P of the repeated pattern 12 is of the same order as the illumination wavelength, or larger than the illumination wavelength. Thus, the defect inspection can be performed reliably, regardless of the pitch P of the repeated pattern 12. This is because the conversion of the linearly polarized light L1 into an elliptically polarized light by the repeated pattern 12 occurs correspondingly to the volume ratio of the line portion 2A and space portion 2B of the repeated pattern 12 and does not depend on the pitch P of the repeated pattern 12.

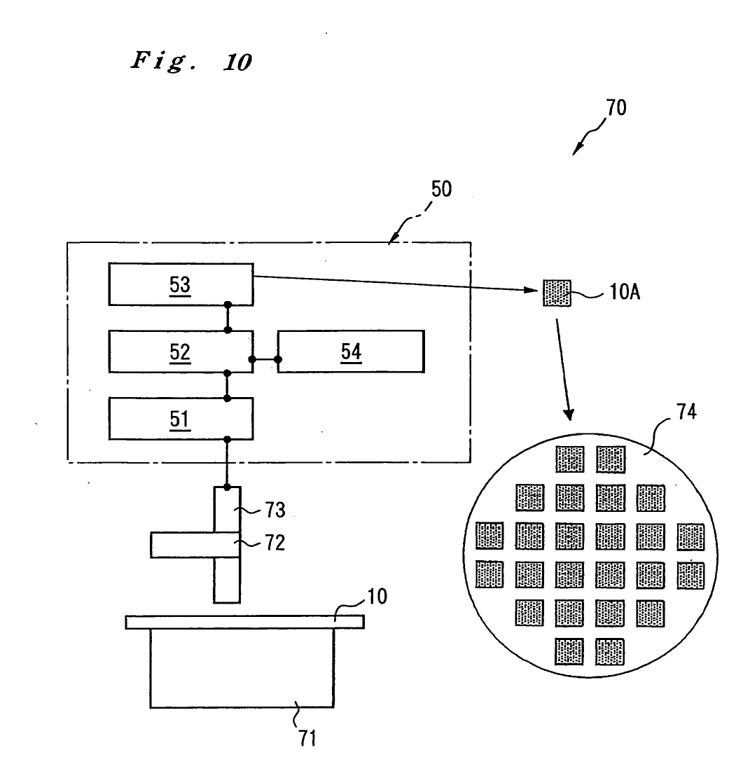

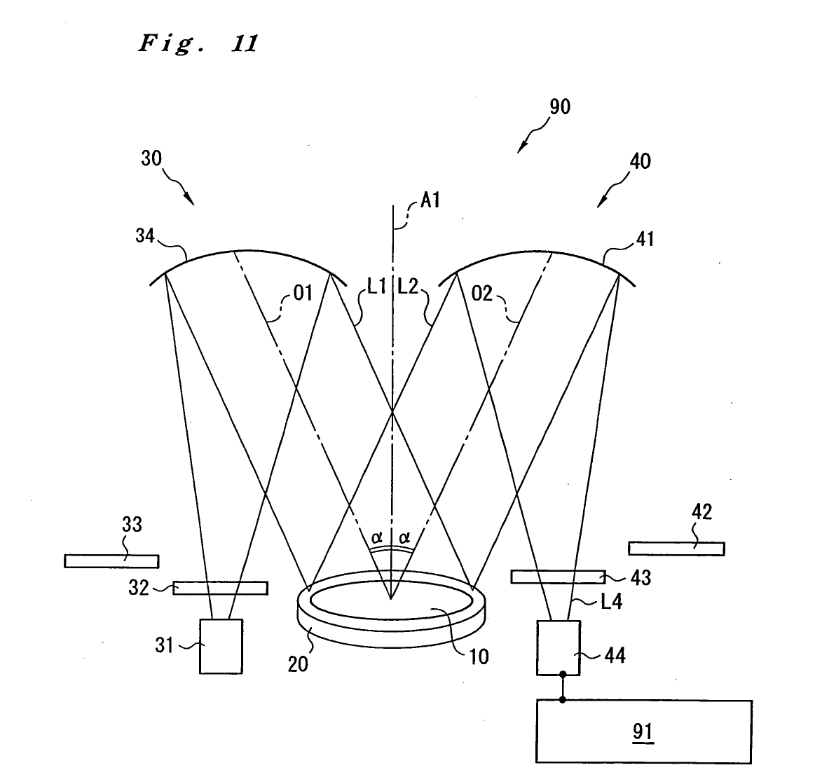

Further, in the above-described embodiment, the pick-up camera 44 is configured to pick-up an image of the entire surface of the wafer 10 at the same time, but such a configuration is not limiting. For example, as shown in FIG. 10, it is also possible to pick up with a pick-up camera 73 for a microscope an enlarged image of part of the surface of the wafer 10 obtained with a polarization microscope 72 and then display the picked-up microscopic image 10A or a synthesized image 74 of the entire wafer surface obtained by synthesizing the picked-up images. As a result, in addition to the possibility of obtaining the same effect as in the above-described embodiment, it is also possible to perform defect inspection of each smaller zone, although this is a time-consuming procedure.

In a surface inspection device 70 of the first modification example shown in FIG. 10, a wafer 10 is held on an alignment stage 71 for a microscope. A microscopic image 10A based on a pick-up camera 73 for a microscope is fetched from the pick-up camera 73 for a microscope to an image storage unit 51 of an image processing device 50. Similarly to the above-described embodiment, an image processing unit 52 inspects defects of a repeated pattern 12 on the wafer 10, and the inspection results and a synthesized image 74 of the entire wafer surface are outputted and displayed by an image output unit 53. Further, in the surface inspection device 70 shown in FIG. 10, the illumination optical system has a configuration identical to that of the above-described embodiment, and detailed explanation thereof and drawing illustrating same are omitted.

In the above-described embodiment, defects of the repeated pattern 12 in the wafer 10 may be detected visually by displaying the reflected image of the wafer 10 that has been picked up by the pick-up camera 44 in an image display unit 91, as shown in FIG. 11, without using the image processing device 50. In this case, the effect identical to that of the above-described embodiment can be also obtained. Further, in the surface inspection device 90 of a second modification example shown in FIG. 11, an alignment stage 20, an illumination optical system 30, and a pick-up optical system 40 have configurations identical to those of the above-described embodiments, they are assigned with identical reference numerals, and detailed explanation thereof is omitted.

Further, in the above-described embodiment, a case is explained in which the linearly polarized light L1 is a p-polarized light, but this feature is not limiting. For example, the linearly polarized light may be an s-polarized light rather than p-polarized light. The s-polarized light is a linearly polarized light with an oscillation plane perpendicular to the incidence plane. Therefore, as shown in FIG. 4, when the repetition direction (X direction) of the repeated pattern 12 in the wafer 10 is set to an angle of 45 degrees to the incidence plane A2 of the linearly polarized light L1 that is the s-polarized light, the angle formed by the orientation of the oscillation plane of the s-polarized light in the surface of the wafer 10 and the repetition direction (X direction) of the repeated pattern 12 is also set to 45 degrees. The p-polarized light is useful for acquiring defect information relating to the edge shape of the line portions 2A of the repeated pattern 12. The s-polarized light is useful for more efficiently grasping the defect information of the surface of the wafer 10 and increasing the S/N ratio.

Furthermore, the linearly polarized light is not limited to the p-polarized light and s-polarized light and may be a light in which the oscillation plane has any inclination with respect to the incidence surface. In this case, it is preferred that the repetition direction (X direction) of the repeated pattern 12 be set to an angle other than 45 degrees to the incidence plane of the linearly polarized light L1 and that an angle formed by the orientation of the oscillation plane of the linearly polarized light L1 in the surface of the wafer 10 and the repetition direction (X direction) of the repeated pattern 12 be set to 45 degrees.

Further, in the above-described embodiment, a configuration is employed that uses a first polarizing plate 32 and light of an ultrahigh-pressure mercury lamp contained in the lamp house 31 and produces the linearly polarized light L1, but such configuration is not limiting, and the first polarizing plate 32 becomes unnecessary when a laser is used as a light source.

Moreover, in the above-described embodiment, the explanation of effect of the first and second phase plates 33, 42 is omitted, but it goes without saying that the phase plates are advantageously used for canceling birefringence of light in the first and second elliptical mirrors 34, 41 and the like.

Further, in the above-described embodiment, the orientation of the transmission axis of the second polarizing plate 43 is set to be inclined at 45 degrees to the transmission axis of the first polarizing plate 32, that is, the oscillation direction of the linearly polarized light L4 in the plane perpendicular to the propagation direction of the linearly polarized light L4 is set to be inclined at 45 degrees to the oscillation direction of the linearly polarized light L1 in the plane perpendicular to the propagation direction of the linearly polarized light L1, but such settings are not limiting. As shown in FIG. 9, where the angle θ is within a range larger than 0 degree and smaller than 90 degrees, the variation in quantity of light becomes larger than that in the case of 90 degrees (when the angle θ is 0 degree, the variation in quantity of light cannot be detected). Therefore, the angle θ (orientation of the transmission axis of the second polarizing plate 43 with respect to the transmission axis of the first polarizing plate 32) may be set within this range. Where the angle θ is less than 45 degrees, the variation in quantity of light decreases, whereas the quantity of background light (light that becomes a noise) increases. Therefore, it is preferred that the angle θ be within a range of 45 degree or more to less than 90 degrees.

What is claimed is:

1. A surface inspection device comprising:
an illumination system to illuminate, with a first linearly polarized light, a surface of a substrate to be inspected that has a repeated pattern formed thereon;
a pick-up system to pick up an image of a reflected light from the surface of the substrate to be inspected; and
an image display system to display the image picked up by the pick-up system,
wherein a polarization element that extracts a second linearly polarized light from the reflected light from the surface of the substrate to be inspected is installed between the substrate to be inspected and the pick-up system, and the pick-up system picks up an image created by a light including the second linearly polarized light, and
wherein the polarization element is set so that an angle at which an oscillation direction of the second linearly polarized light in a plane perpendicular to a propagation direction of the second linearly polarized light is inclined to an oscillation direction of the first linearly polarized light in a plane perpendicular to a propagation direction of the first linearly polarized light is larger than 0 degree and smaller than 90 degrees.

2. The surface inspection device according to claim 1, wherein the polarization element is set so that an angle at which the oscillation direction of the second linearly polarized light in the plane perpendicular to the propagation direction of the second linearly polarized light is inclined to the oscillation direction of the first linearly polarized light in the plane perpendicular to the propagation direction of the first linearly polarized light is equal to or larger than 45 degrees and smaller than 90 degrees.

3. The surface inspection device according to claim 1, wherein the polarization element is set so that an angle at which the oscillation direction of the second linearly polarized light in the plane perpendicular to the propagation direction of the second linearly polarized light is inclined to the oscillation direction of the first linearly polarized light in the plane perpendicular to the propagation direction of the first linearly polarized light is approximately 45 degrees.

4. The surface inspection device according to claim 1, wherein the pick-up system picks up the entire repeated pattern.

5. A surface inspection device comprising:
an illumination system to illuminate, with a first linearly polarized light, a surface of a substrate to be inspected that has a repeated pattern formed thereon;
a pick-up system for picking up an image of a reflected light from the surface of the substrate to be inspected;
an image processing unit to perform a predetermined image processing on the image picked up by the pick-up system and to detect a defect of the repeated pattern; and
an image output unit to output results of the image processing performed by the image processing unit,
wherein a polarization element that extracts a second linearly polarized light from the reflected light from the surface of the substrate to be inspected is installed between the substrate to be inspected and the pick-up system, and the pick-up system picks up an image created by a light including the second linearly polarized light, and
wherein the polarization element is set so that an angle at which an oscillation direction of the second linearly polarized light in a plane perpendicular to a propagation direction of the second linearly polarized light is inclined to an oscillation direction of the first linearly polarized light in a plane perpendicular to a propagation direction of the first linearly polarized light is larger than 0 degree and smaller than 90 degrees.

6. The surface inspection device according to claim 5, wherein the polarization element is set so that an angle at which an oscillation direction of the second linearly polarized light in a plane perpendicular to a propagation direction of the second linearly polarized light is inclined to an oscillation direction of the first linearly polarized light in a plane perpendicular to a propagation direction of the first linearly polarized light is equal to or larger than 45 degrees and smaller than 90 degrees.

7. The surface inspection device according to claim 5, wherein the polarization element is set so that an angle at which the oscillation direction of the second linearly polarized light in the plane perpendicular to the propagation direction of the second linearly polarized light is inclined to the oscillation direction of the first linearly polarized light in the plane perpendicular to the propagation direction of the first linearly polarized light is approximately 45 degrees.

8. The surface inspection device according to claim 1, further comprising a holding unit to hold the substrate to be inspected so that an angle formed by an orientation of an oscillation plane of the first linearly polarized light at the surface of the substrate to be inspected and a repetition direction of the repeated pattern is a predetermined angle,
wherein the predetermined angle is set to approximately 45 degrees by the holding unit.
